(19) United States
(12) Patent Application Publication
(10) Pub. No.: US 2026/0371418 A1
(43) Pub. Date: Nov. 19, 2026

(54) COMMUNICATION METHOD, ELECTRONIC DEVICE, AND STORAGE MEDIUM

(71) Applicant: Beijing Xiaomi Mobile Software Co., Ltd., Beijing (CN)

(72) Inventor: Yajun CHENG, Beijing (CN)

(73) Assignee: Beijing Xiaomi Mobile Software Co., Ltd., Beijing (CN)

(21) Appl. No.: 19/477,371

(22) PCT Filed: Apr. 21, 2023
(86) PCT No.: PCT/CN2023/089917

§ 371 Date: Oct. 21, 2025

(51) Int. Cl. H04W 76/14; H04W 74/02

(52) U.S. Cl. CPC H04W 76/14; H04W 74/02

(57) ABSTRACT

A communication method includes: determining a first frame, wherein the first frame includes first identification information, the first identification information indicates a portion of an obtained TXOP allocated by an AP to a first TDLS device, the portion of the obtained TXOP is used for the first TDLS device to perform low latency traffic transmission with a second TDLS device over a TDLS direct link, and the first TDLS device and the second TDLS device are both members of a first R-TWT schedule; and sending the first radio frame in a first R-TWT SP.

### CROSS REFERENCE TO RELATED APPLICATIONS

The present disclosure is the U.S. national phase application of International Application No. PCT/CN2023/089917 filed on Apr. 21, 2023, the content of which is incorporated herein by reference in its entirety for all purposes.

### TECHNICAL FIELD

The present disclosure relates to the field of mobile communication technology, in particular, to a communication method, an electronic device, and a storage medium.

### BACKGROUND

The Peer to Peer (P2P) communication method for data transmission does not need an access point, avoiding the delay caused by network congestion and further improving the transmission efficiency. To ensure the low latency traffic transmission, a Restricted Target Wake Time (R-TWT) is also proposed.

### SUMMARY

In one aspect of the present disclosure, a communication method is provided, and is performed by an access point (AP). The method includes:
determining a first frame, wherein the first frame includes first identification information, the first identification information indicates a portion of an obtained Transmission Opportunity (TXOP) allocated by the AP to a first Tunneled Direct Link Setup (TDLS) device, and the portion of the obtained TXOP is used for the first TDLS device to perform low latency traffic transmission with a second TDLS device over a TDLS direct link, and wherein the first TDLS device and the second TDLS device are both members of a first Restricted Target Wake Time (R-TWT) schedule; and sending the first frame within a first R-TWT Service Period (SP).

In another aspect of the present disclosure, a communication method is provided, and is performed by a first TDLS device. The method includes: receiving a first frame within a first R-TWT SP, wherein the first frame includes first identification information, the first identification information indicates a portion of an obtained TXOP allocated by an AP to the first TDLS device, and the portion of the obtained TXOP is used for the first TDLS device to perform low latency traffic transmission with a second TDLS device over a TDLS direct link, and wherein the first TDLS device and the second TDLS device are both members of a first R-TWT schedule.

In another aspect of the present disclosure, an electronic device is provided. The electronic device is an access point (AP), and includes:
a determination module configured to determine a first frame, wherein the first frame includes first identification information, the first identification information indicates a portion of an obtained TXOP allocated by the AP to a first TDLS device, and the portion of the obtained TXOP is used for the first TDLS device to perform low latency traffic transmission with a second TDLS device over a TDLS direct link, and wherein the first TDLS device and the second TDLS device are both members of a first R-TWT schedule; and a sending module configured to send the first frame within a first R-TWT SP.

In another aspect of the present disclosure, an electronic device is provided. The electronic device is a first TDLS device, and includes: a receiving module configured to receive a first frame within a first R-TWT SP, wherein the first frame includes first identification information, the first identification information indicates a portion of an obtained TXOP allocated by an AP to the first TDLS device, and the portion of the obtained TXOP is used for the first TDLS device to perform low latency traffic transmission with a second TDLS device over a TDLS direct link, and wherein the first TDLS device and the second TDLS device are both members of a first R-TWT schedule.

The present disclosure also provides an electronic device including a memory, a processor, and a computer program stored on the memory and executable by the processor, wherein the processor is configured to execute the computer program to implement the methods described in one or more embodiments of the present disclosure.

The present disclosure also provides a non-transitory computer-readable storage medium having a computer program stored thereon, which when executed by a processor, causes the methods described in one or more embodiments of the present disclosure to be implemented.

The additional aspects and advantages of embodiments of the present disclosure will be partially provided in the following description, which will become apparent from the following description or will be understood through practice of the present disclosure.

### BRIEF DESCRIPTION OF THE DRAWINGS

In order to provide a clearer explanation of technical solutions in embodiments of the present disclosure, a brief introduction to the drawings required in the description of embodiments of the present disclosure will be provided in the following. It is apparent that the drawings are only some of the embodiments of the present disclosure, and for those skilled in the art, other drawings can be obtained based on these drawings without creative efforts.

FIG. 1 is an interactive schematic diagram of a communication method according to embodiments of the present disclosure;

FIG. 2 is another interactive schematic diagram of a communication method according to embodiments of the present disclosure;

FIG. 3 is a first flowchart of a communication method according to embodiments of the present disclosure;

FIG. 4 is a second flowchart of a communication method according to embodiments of the present disclosure;

FIG. 5 is a first schematic diagram of a structure of an electronic device according to embodiments of the present disclosure;

FIG. 6 is a second schematic diagram of a structure of an electronic device according to embodiments of the present disclosure; and

FIG. 7 is a third schematic diagram of a structure of an electronic device according to embodiments of the present disclosure.

### DETAILED DESCRIPTION

A detailed explanation of exemplary embodiments will be provided herein, with examples being illustrated in the drawings. The same reference numerals in different drawings represent the same or similar elements when the following description refers to the drawings, unless otherwise indicated. The implementations described in the following exemplary embodiments do not represent all implementations consistent with the present disclosure, instead, they are only examples of devices and methods consistent with some aspects of the present disclosure as detailed in the appended claims.

The terms used in embodiments of the present disclosure are for the purpose of description of specific embodiments only, and are not intended to limit the embodiments of the present disclosure. Singular forms such as “a”, “said”, and “the” used in embodiments of the present disclosure and the appended claims are also intended to include plural forms, unless other meanings are clearly indicated in the context. It should also be understood that the term “and/or” used in the present disclosure refers to and includes any or all possible combinations of one or more listed items related. For example, A and/or B can indicate the presence of A alone, the presence of A and B simultaneously, and the presence of B alone. The character “/” generally indicates that associated objects have an “or” relationship between them. The term “multiple” refers to two or more, and therefore, in embodiments of the present disclosure, “multiple” can also be understood as “at least two”.

It should be understood that although terms such as first, second, and third may be used to describe various information in embodiments of the present disclosure, such information should not be limited to these terms, which are only used to distinguish information about the same type from each other. For example, without departing from the scope of the present disclosure, the first information can also be referred to as the second information, and similarly, the second information can also be referred to as the first information. The word “if” used herein can be interpreted as “when” or “while” or “in response to determination that”, depending on the context.

A clear and complete description of technical solutions disclosed in the embodiments of the present disclosure will be provided in the following, in conjunction with the drawings. Obviously, the embodiments described are only a part of disclosed embodiments of the present disclosure and not all of them. Based on the embodiments of the present disclosure, all other embodiments obtained by those of ordinary skill in the art without creative efforts fall within the protection scope of the present disclosure.

Embodiments of the present disclosure provide a communication method, an electronic device, and a storage medium, to provide a low latency traffic transmission method.

In some embodiments, the method and the device are based on the same application concept. Due to the similar principles for solving problems used by the method and the device, the implementations of the device and the method can be referred to each other, which will not be repeated.

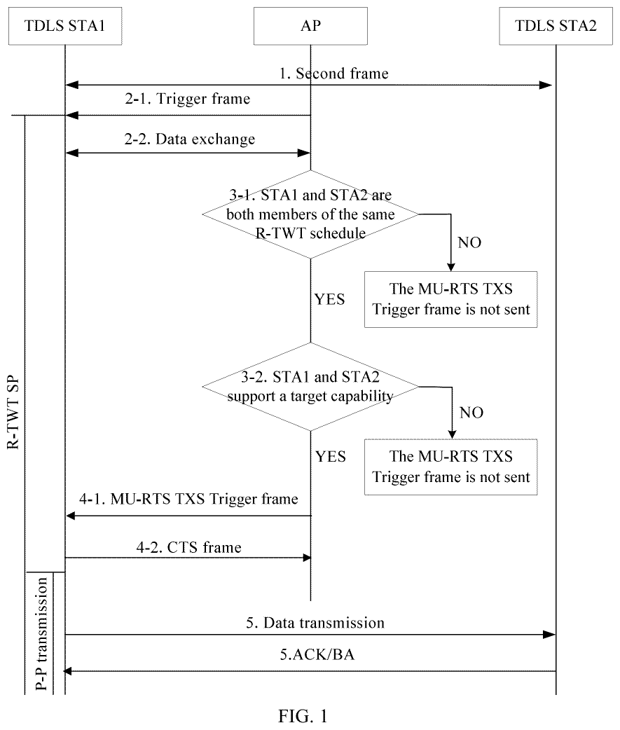

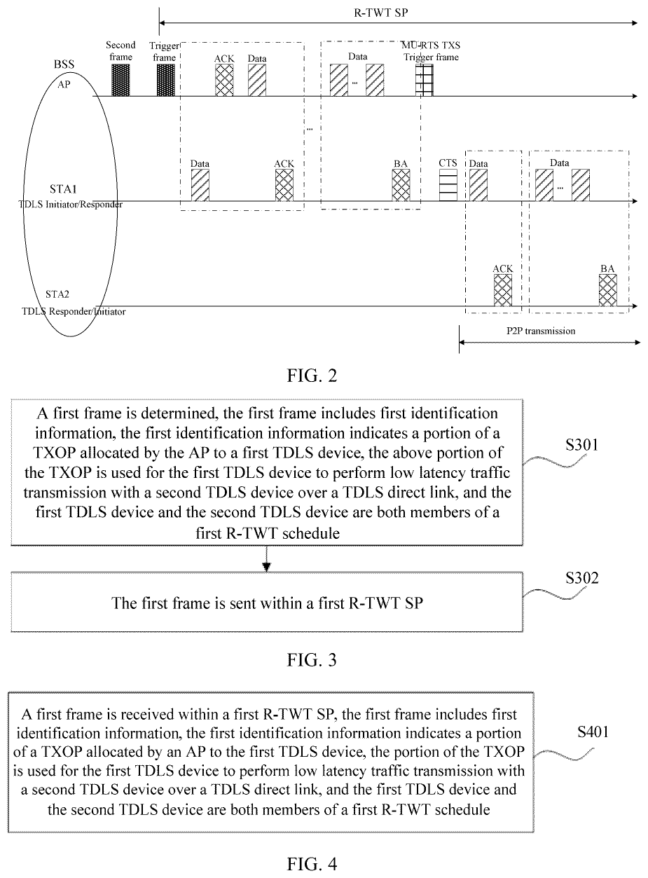

As a first example, as shown in FIGS. 1 and 2, examples of communication methods provided in various embodiments of the present disclosure will be explained. As shown in FIGS. 1 and 2, an AP (Access Point), an STA1 (a first TDLS (Tunneled Direct Link Setup) device, i.e., a first station), and an STA2 (a second TDLS device, i.e., a second station) are in the same Basic Service Set (BSS), where the STA1 and the STA2 are peer devices. In some embodiments, all operations performed by the STA1 can also be performed by the STA2 in a peer manner. In some embodiments of the present disclosure, the STA1 and the STA2 can be collectively referred to as the STA, where the STA can also be a non-AP MLD device (Multi-Link Device).

In step 1, the AP broadcasts an R-TWT (Restricted Target Wake Time) schedule through a second frame, the R-TWT supports devices in performing the low latency traffic transmission over a TDLS direct link within a corresponding R-TWT SP (Service Period). The first station STA1 and the second station STA2 can join the R-TWT schedule through a TWT Setup frame and become members of the R-TWT schedule.

In some embodiments, the second frame can be a Beacon frame or a Probe Response frame. The second frame includes a TWT element, which includes a Broadcast TWT Parameter Set field. The Broadcast TWT Parameter Set field includes a Request Type subfield, which includes a Broadcast TWT Recommendation field.

Second identification information is included in the Broadcast TWT Recommendation field, and the Broadcast TWT Recommendation field indicates whether the low latency traffic transmission between TDLS devices over the TDLS direct link (i.e., TDLS channel) is supported within the corresponding R-TWT SP.

When the Broadcast TWT Recommendation field is set to 5, it indicates that the low latency traffic transmission between TDLS devices over the TDLS direct link is supported within the R-TWT SP.

In step 2-1, the AP sends a trigger frame (e.g., Basic Trigger frame) to the STA1 within the R-TWT SP to wake up the STA1 to exchange data with the AP.

In step 2-2, the AP exchanges data with the STA1. In the data exchange process, the exchanged data can be an independent data frame or multiple consecutive data frames (i.e., the data block).

In the data exchange process, when the receiver (i.e., AP or STA1) receives an independent data frame, the receiver can feed back an acknowledgement frame (ACK frame) to the sender (i.e., STA1 or AP). When the receiver receives multiple consecutive data frames, the receiver can feed back a Block ACK (BA) frame to the sender.

For example, as shown in FIG. 2, the STA1 sends a data frame to the AP, and after receiving the data frame, the AP sends an ACK frame to the STA1. The AP sends a set of multiple consecutive data frames to the STA1, and after receiving the set of data frames, the STA1 sends a BA frame to the AP.

In step 3-1, the AP determines whether the STA1 and the STA2 are both members of the same R-TWT schedule.

In step 3-2, the AP determines whether the STA1 and the STA2 support a target capability. In some embodiments, the target capability is to perform the low latency traffic transmission over the TDLS direct link within the first R-TWT SP. When the Triggered TXOP Sharing Mode 2 Support subfield is set to 1 (i.e., a first parameter value), it indicates that the STA supports the target capability. When the Triggered TXOP Sharing Mode 2 Support subfield is set to 0 (i.e., a second parameter value), it indicates that the STA does not support the target capability.

The execution order of steps 3-1 and 3-2 mentioned above is not specified. It is possible to first determine whether the STA is a member of the R-TWT schedule, or to first determine whether the STA has target capability information. It is also possible to simultaneously determine whether the STA is a member of the R-TWT schedule and whether the STA has target capability information. This can be chosen according to actual needs.

In some embodiments, when determining whether the STA1 supports the target capability information or not, it can be determined through the EHT (Extremely High Throughput) MAC (Media Access Control) Capabilities Information field of the STA. In some embodiments, the EHT MAC Capabilities Information field is included in the EHT Capabilities element, specifically included in the Triggered TXOP Sharing Mode 2 Support subfield of the EHT Capabilities element. The EHT Capabilities element can be included in the TDLS Setup Request frame or the TDLS Setup Response frame.

In some embodiments, if the AP determines that the STA1 does not support the target capability, an MU-RTS TXS Trigger frame will not be sent.

In some embodiments, when the AP determines that the STA1 and the STA2 are not members of the same R-TWT schedule, the MU-RTS TXS Trigger frame will not be sent to the STA1.

In step 4-1, in the case where the AP determines that the STA1 and the STA2 are both members of the same R-TWT schedule and that the STA1 supports the target capability, an MU-RTS TXS Trigger frame (Multi-User Request to Send Transmission Opportunity Sharing Trigger frame, i.e., a first frame) is sent to the STA1, to allocate a portion of a TXOP for the STA1.

The MU-RTS TXS Trigger frame includes a common information (Common Info) field, which includes a Triggered TXOP Sharing Mode subfield, where TXOP stands for Transmission Opportunity. The first identification information can be included in the Triggered TXOP Sharing Mode subfield.

When the Triggered TXOP Sharing Mode subfield is set to 2, it indicates that the STA1 can perform, within a portion of a TXOP allocated by the AP, the low latency traffic transmission with the STA2 over the TDLS direct link. In some embodiments, the portion of the TXOP is used for the STA1 to perform the low latency traffic transmission with the STA2 over the TDLS direct link.

In step 4-2, after receiving the MU-RTS TXS Trigger frame, the STA1 sends a CTS (Clear to Send) frame to the AP, which is a response to the MU-RTS TXS Trigger frame sent by the AP.

In step 5, the STA1 performs P2P (Peer to Peer) transmission with the STA2, that is, the STA1 sends data to the STA2.

In the data transmission process, after receiving the data frame sent by the sender (i.e., STA1), the receiver (i.e., STA2) can feed back an acknowledgement frame (ACK frame) to the sender. When receiving multiple consecutive data frames sent by the sender, the receiver can feed back a BA frame to the sender.

Specifically, as shown in FIG. 2, the P2P transmission process can be as follows: the STA1 sends a data frame to the STA2. After receiving the data frame, the STA2 feeds back an ACK frame to the STA1. The STA1 sends a set of multiple consecutive data frames to the STA2. After receiving the set of data frames, the STA2 feeds back a BA frame to the STA1.

It should be noted that, as described in the aforementioned text, the STA1 and the STA2 are peer devices. The above embodiments are based on an example of the STA1 sending data to the STA2, and the methods are also applicable to the case where the STA2 sends data to the STA1. In some embodiments, taking the main execution steps as an example. In step 2-2, the AP can also exchange data with the STA2. Correspondingly, in step 4-1, when the AP determines that the STA1 and the STA2 are both members of the same R-TWT schedule and the STA2 supports the target capability, the AP sends the MU-RTS TXS Trigger frame to the STA2. In step 4-2, the STA2 can send the CTS frame to the AP. In step 5, the STA2 performs P2P (Peer to Peer) transmission with the STA1, that is, the STA2 sends data to the STA1.

In this way, based on the MU-RTS TXS Trigger frame including the first identification information, the AP allocates a portion of a TXOP to the STA. For the R-TWT schedule that can be applied between STA devices, the low latency traffic transmission can be performed, within the portion of the TXOP, by STAs over the successfully established TDLS direct link, without the participation of the AP, further reducing the transmission delay in the low latency traffic transmission process and improving the transmission efficiency of the low latency traffic transmission.

In embodiments of the present disclosure, the AP determines the first frame and sends the first frame within a first R-TWT SP. In the first frame, a portion of a TXOP allocated by the AP to the first TDLS device is indicated through the first identification information. The portion of the TXOP is used for the first TDLS device to perform low latency traffic transmission with a second TDLS device over a TDLS direct link. For the R-TWT schedule that can be applied between TDLS devices, the low latency traffic transmission can be performed, within the portion of the TXOP, between the TDLS devices over the TDLS direct link, further reducing the transmission delay during the low latency traffic transmission and improving the transmission efficiency of the low latency traffic. Embodiments of the present disclosure provide a low latency traffic transmission method.

As shown in FIG. 3, embodiments of the present disclosure provide a communication method, which can be performed by an access point (AP). In some embodiments of the present disclosure, the AP is, for example, a device with wireless to wired bridging functionality, and is responsible for extending services provided by the wired network to the wireless network. The station is, for example, an electronic device with wireless network access functionality, and provides frame delivery services to facilitate the transmission of information. In some embodiments of the present disclosure, the AP and the STA can be devices that support multiple links. For example, the AP and the STA can be represented as an AP MLD and a non-AP MLD, respectively. The AP MLD can represent an access point that supports multi-link communication functionality, and the non-AP MLD can represent a station that supports multi-link communication functionality.

The method can include following steps.

In step 301, a first frame is determined, the first frame includes first identification information, and the first identification information indicates a portion of a TXOP allocated by the AP to a first TDLS device. The above portion of the TXOP is used for the first TDLS device to perform low latency traffic transmission with a second TDLS device over a TDLS direct link. In some embodiments, the first TDLS device and the second TDLS device are both members of a first R-TWT schedule.

In step 302, the first frame is sent within a first R-TWT SP.

The TWT is a technology used for energy conservation, which is aimed at further reducing the power consumption of the Wi-Fi network. Specifically, the TWT technology determines the sleep and wake-up time and frequencies of the STA by negotiating the Service Period between the STA and the AP. The STA remains in an active state and communicates during this Service Period, allowing it to sleep outside of the Service Period for energy-saving purpose. In addition, the TWT technology can enable the AP to provide higher quality services to multiple STAs, minimize competition or overlap, and improve spectrum efficiency while reducing the power consumption of the Wi-Fi network.

In low latency transmission scenarios, many applications have strict latency requirements for real-time traffic, such as average or maximum latency ranging from a few milliseconds to tens of milliseconds, and the applications require real-time traffic to have minimal jitter and strong reliability. In order to further ensure the communication of low latency traffic, the Restricted Target Wake Time (R-TWT) is proposed based on the TWT technology. The R-TWT mechanism allows the AP to use enhanced media access protection and resource reservation mechanisms to provide more predictable latency, to distinguish delay sensitive traffic from other types of traffic, reduce worst-case latency and/or jitter, and provide more reliable services.

In some embodiments of the present disclosure, a scheduling device (such as AP, also referred to as scheduling AP) and a scheduled device (such as STA, also referred to as scheduled STA) of the R-TWT can establish the R-TWT schedule in advance. The AP broadcasts the R-TWT schedule, and the STA negotiates with the AP to become a member of a certain R-TWT schedule. During the corresponding R-TWT traffic phase, the AP and the STA only transmit the low latency traffic corresponding to the uplink and downlink indicated by the R-TWT schedule, while communication of other traffic is suspended or postponed during that phase. Specifically, the R-TWT is used to serve the low latency traffic, such as those with an average latency of less than 10 milliseconds. In the R-TWT SP, only communication of the traffic identified as the low latency traffic is allowed to be carried out, while communication of other traffic is suspended or postponed during that phase to ensure the low latency traffic transmission.

The AP determines the first frame. In some embodiments, the first frame includes the first identification information, which indicates a portion of a TXOP allocated by the AP for the first TDLS device. The above portion of the TXOP is used for the first TDLS device to perform the low latency traffic transmission with the second TDLS device over the TDLS direct link. The first TDLS device and the second TDLS device are both members of the first R-TWT schedule. In some embodiments, the first TDLS device and the second TDLS device can be, for example, two STAs. The TDLS technology enables two STAs in the same Basic Service Set to directly skip the AP to transmit data after a TDLS direct link (TDLS channel) is established, without being constrained by the AP, so that the fastest rate standard supported by the two STAs can be used for direct transmission. The direct transmission can be carried out on the original link or switched to a new spread channel, thus avoiding the data transmission delay caused by network congestion, which is of great significance for the low latency traffic transmission.

In some embodiments of the present disclosure, the AP identifies the portion of the TXOP allocated by the AP to the first TDLS device through the first identification information. For the R-TWT schedule that can be applied between STAs, the low latency traffic transmission can be performed, within a portion of a TXOP, between the first TDLS device and the second TDLS device over the TDLS direct link established between them, without the participation of the AP, further reducing the transmission delay during the low latency traffic transmission and improving the transmission efficiency of the low latency traffic.

In the communication method performed by the AP provided in embodiments of the present disclosure, the above method can further include following steps.

If it determines that both the first TDLS device and the second TDLS device support the target capability, the first frame is determined.

In some embodiments, the target capability includes performing the low latency traffic transmission over the TDLS direct link within the first R-TWT SP.

In some embodiments of the present disclosure, the first TDLS device and the second TDLS device can be collectively referred to as TDLS devices.

The AP can determine whether the TDLS device supports the target capability based on the received third frame, which relates to whether the TDLS device supports the target capability. The third frame can be directly sent by the TDLS device to the AP, or forwarded to the AP through other APs associated with the TDLS device.

In some embodiments, the third frame can be a TDLS Setup Request frame or a TDLS Setup Response frame received. Specifically, the third frame can be the TDLS Setup Request frame initiated by the TDLS device or the TDLS Setup Response frame received by the TDLS device in the process of establishing a TDLS direct link between the first TDLS device and the second TDLS device.

It can be understood that, taking that the third frame is a frame corresponding to the first TDLS device as an example, when the first TDLS device is an initiator in establishing the TDLS direct link, a field indicating whether the first TDLS device supports the target capability can be included in the TDLS Setup Request frame. When the first TDLS device is a responder in establishing the TDLS direct link, a field indicating whether the first TDLS device supports the target capability can be included in the TDLS Setup Response frame. Whether the first TDLS device supports the target capability is determined by including a field indicating whether the first TDLS device supports the target capability.

In the communication method performed by the AP provided in embodiments of the present disclosure, determining the first frame as described above can include: determining whether the TDLS device supports the target capability based on EHT MAC Capabilities Information transmitted by the TDLS device.

The TDLS device includes the first TDLS device and/or the second TDLS device.

The above third frame can include the EHT MAC Capabilities Information, that is, the information indicating whether the TDLS device supports the target capability.

In the communication method performed by the AP provided in embodiments of the present disclosure, when a Triggered TXOP Sharing Mode 2 Support subfield of the EHT MAC Capabilities Information is set to a first parameter value, it indicates that the TDLS device supports the above target capability.

In some embodiments, the EHT MAC Capabilities Information is included in an EHT Capabilities element.

Specifically, the above third frame can be the TDLS Setup Request frame or the TDLS Setup Response frame, which can include an EHT Capabilities element, the EHT Capabilities element including the EHT MAC Capabilities Information. The EHT MAC Capabilities Information can include the Triggered TXOP Sharing Mode 2 Support subfield.

When the Triggered TXOP Sharing Mode 2 Support subfield is set to the first parameter value, it indicates that the TDLS device supports the target capability. That is, the TDLS device can perform, within the first R-TWT SP, the low latency traffic transmission over the TDLS direct link. In some embodiments, the first parameter value can be 1.

Specifically, when the Triggered TXOP Sharing Mode 2 Support subfield is set to 1, it can indicate that the TDLS device supports the target capability. When the Triggered TXOP Sharing Mode 2 Support subfield is set to 0, it can indicate that the TDLS device does not support the target capability, that is, the TDLS device cannot perform, within the first R-TWT SP, the low latency traffic transmission over the TDLS direct link.

In the communication method performed by the AP provided in embodiments of the present disclosure, the above first frame includes an MU-RTS TXS Trigger frame.

In some embodiments, the MU-RTS TXS Trigger frame can include a common information field, which includes a Triggered TXOP Sharing Mode subfield. The first identification information can be included in the Triggered TXOP Sharing Mode subfield.

When the Triggered TXOP Sharing Mode subfield is set to 2, it identifies a portion of a Transmission Opportunity (TXOP) allocated by the AP to the first TDLS device, which indicates that the first TDLS device can perform, within the portion of the TXOP, the low latency traffic transmission with the second TDLS device over the TDLS direct link.

The communication method performed by the AP provided in embodiments of the present disclosure can further include following steps.

A second frame is determined, the second frame includes second identification information, and the second identification information indicates whether the R-TWT schedule supports the TDLS device to perform, within a corresponding SP, the low latency traffic transmission over the TDLS direct link; and the second frame is sent.

In some embodiments, the second frame includes a Beacon frame or a Probe Response frame. In some embodiments, the Probe Response frame can be an unrequested Probe Response frame.

The R-TWT schedule can be broadcasted through the second frame.

Specifically, the second frame can include the second identification information, which indicates whether the broadcasted R-TWT schedule supports the TDLS device to perform the low latency traffic transmission over the TDLS direct link within the corresponding SP.

In the communication method performed by the AP provided in embodiments of the present disclosure, the second frame includes a TWT element.

The TWT element includes a Broadcast TWT Parameter Set field.

The Broadcast TWT Parameter Set field includes a Request Type subfield, which includes a Broadcast TWT Recommendation field.

The second identification information is included in the above Broadcast TWT Recommendation field.

The second frame can include the TWT element, which can include the Broadcast TWT Parameter Set field. The Broadcast TWT Parameter Set field can include the Request Type subfield, which can include the Broadcast TWT Recommendation field. The Broadcast TWT Recommendation field can include the second identification information.

The value of the Broadcast TWT Recommendation field can be a third parameter value, which can be set according to actual needs. When the value of the Broadcast TWT Recommendation field is set to different values, the indicated contents are also different. For example, if the third parameter value is 5, it indicates that the R-TWT SP can be used for the low latency traffic transmission performed between TDLS devices over the TDLS direct link. An example is shown in Table 1 below.

TABLE 1

| Broadcast TWT | |
|---|---|
| Recommendation | |
| field value | Description |
| . . . | . . . |
| 5 | The low latency communication traffic transmission |
| | can be directly performed between TDLS devices over |
| | the TDLS direct link within the corresponding R-TWT |
| | SP. |
| . . . | Reserved |

In embodiments of the present disclosure, the AP indicates the portion of the TXOP allocated by the AP to the first TDLS device through the first identification information. For the R-TWT schedule that can be applied between STAs, the low latency traffic transmission can be performed, within the portion of the TXOP, between the first TDLS device and the second TDLS device over the TDLS direct link established between them, without the participation of the AP, further reducing the transmission delay during the low latency traffic transmission and improving the transmission efficiency of the low latency traffic.

Embodiments of the present disclosure provide a communication method, which is performed by an access point (AP). The method can include following steps.

A first frame is determined, the first frame includes first identification information, and the first identification information indicates a portion of a TXOP allocated by the AP to a first TDLS device. The above portion of the TXOP is used for the first TDLS device to perform low latency traffic transmission with a second TDLS device over a TDLS direct link. In some embodiments, the first TDLS device and the second TDLS device are both members of a first R-TWT schedule.

The first frame is sent within a first R-TWT SP.

The above method can further include following steps.

If it determines that both the first TDLS device and the second TDLS device support the target capability, the first frame is determined.

In some embodiments, the target capability includes performing the low latency traffic transmission over the TDLS direct link within the first R-TWT SP.

Determining the first frame as described above can include: determining whether the TDLS device supports the target capability based on EHT MAC Capabilities Information transmitted by the TDLS device.

The TDLS device includes the first TDLS device and/or the second TDLS device.

When a Triggered TXOP Sharing Mode 2 Support subfield of the EHT MAC Capabilities Information is set to a first parameter value, it indicates that the TDLS device supports the above target capability.

The EHT MAC Capabilities Information is included in an EHT Capabilities element.

The above first frame includes an MU-RTS TXS Trigger frame.

The above method can further include following steps.

A second frame is determined, the second frame includes second identification information, and the second identification information indicates whether the R-TWT schedule supports the TDLS device to perform, within a corresponding SP, the low latency traffic transmission over the TDLS direct link; and the second frame is sent.

The second frame includes a TWT element.

The TWT element includes a Broadcast TWT Parameter Set field.

The Broadcast TWT Parameter Set field includes a Request Type subfield, which includes a Broadcast TWT Recommendation field.

The second identification information is included in the above Broadcast TWT Recommendation field.

In embodiments of the present disclosure, the AP indicates the portion of the TXOP allocated by the AP to the first TDLS device through the first identification information. For the R-TWT schedule that can be applied between TDLS devices, the low latency traffic transmission can be performed, within the portion of the TXOP, between the first TDLS device and the second TDLS device over the TDLS direct link established between them, without the participation of the AP, further reducing the transmission delay during the low latency traffic transmission and improving the transmission efficiency of the low latency traffic.

As shown in FIG. 4, embodiments of the present disclosure provide a communication method, which is performed by a first TDLS device. The method includes following steps.

In step 401, a first frame is received within a first R-TWT SP.

In some embodiments, the first frame includes first identification information, and the first identification information indicates a portion of a TXOP allocated by an AP to the first TDLS device. The above portion of the TXOP is used for the first TDLS device to perform low latency traffic transmission with a second TDLS device over a TDLS direct link. In some embodiments, the first TDLS device and the second TDLS device are both members of a first R-TWT schedule.

In some embodiments of the present disclosure, the AP broadcasts the R-TWT schedule to the first TDLS device and the second TDLS device, respectively, to determine whether both the first TDLS device and the second TDLS device are members of the first R-TWT schedule.

Within the first R-TWT SP, the first TDLS device receives the first frame, and determines whether the AP allocates a portion of a TXOP to the first TDLS device based on the first identification information in the first frame. After determining that the AP has allocated the portion of the TXOP to the first TDLS device, the first TDLS device can perform the low latency traffic transmission with the second TDLS device over the TDLS direct link.

In embodiments of the present disclosure, the first TDLS device receives the first frame within the R-TWT SP, and determines, based on the first identification information in the first frame, that the AP has allocated the portion of the TXOP to the first TDLS device. For the R-TWT schedule that can be applied between TDLS devices, the low latency traffic transmission can be performed, within the portion of the TXOP, between the first TDLS device and the second TDLS device over the TDLS direct link established between them, without the participation of the AP, further reducing the transmission delay during the low latency traffic transmission and improving the transmission efficiency of the low latency traffic.

In the communication method performed by the first TDLS device provided in embodiments of the present disclosure, if both the first TDLS device and the second TDLS device support the target capability, the first frame is determined.

In some embodiments, the target capability includes performing the low latency traffic transmission over the TDLS direct link within the first R-TWT SP.

In some embodiments of the present disclosure, the first TDLS device can determine whether the second TDLS device supports the target capability through a TDLS Setup Request frame or a TDLS Setup Response frame in the process of establishing the TDLS direct link.

Specifically, when the second TDLS device is an initiator in establishing the TDLS direct link, a field indicating whether the second TDLS device supports the target capability can be included in the TDLS Setup Request frame. When the second TDLS device is a responder in establishing the TDLS direct link, a field indicating whether the second TDLS device supports the target capability can be included in the TDLS Setup Response frame. Whether the second TDLS device supports the target capability is determined by including a field indicating whether the second TDLS device supports the target capability.

In the communication method performed by the first TDLS device provided in embodiments of the present disclosure, EHT MAC Capabilities Information is included in the TDLS Setup Request frame or the TDLS Setup Response frame, and the EHT MAC Capabilities Information is configured to indicate whether the first TDLS device supports the above target capability.

The EHT MAC Capabilities Information included in the TDLS Setup Request frame or the TDLS Setup Response frame can indicate whether the first TDLS device supports the target capability. That is, when the first TDLS device is an initiator in establishing the TDLS direct link, the EHT MAC Capabilities Information can be included in the TDLS Setup Request frame, which indicates whether the first TDLS device supports the target capability. When the first TDLS device is a responder in establishing the TDLS direct link, the EHT MAC Capabilities Information can be included in the TDLS Setup Response frame, which indicates whether the first TDLS device supports the target capability.

Similarly, when the second TDLS device (i.e. the other end of the TDLS direct link) is a responder in establishing the TDLS direct link, the EHT MAC Capabilities Information can be included in the TDLS Setup Response frame, which can be used to determine whether the second TDLS device supports the target capability. When the second TDLS device is an initiator in establishing the TDLS direct link, the EHT MAC Capabilities Information can be included in the TDLS Setup Request frame, which can be used to determine whether the second TDLS device supports the target capability.

In the communication method performed by the first TDLS device provided in embodiments of the present disclosure, when a Triggered TXOP Sharing Mode 2 Support subfield of the EHT MAC Capabilities Information is set to a first parameter value, it indicates that the first TDLS device supports the target capability.

In some embodiments, the EHT MAC Capabilities Information is included in an EHT Capabilities element.

Specifically, the TDLS Setup Request frame or the TDLS Setup Response frame can include the EHT Capabilities element, the EHT Capabilities element can include the EHT MAC Capabilities Information, and the EHT MAC Capabilities Information can include the Triggered TXOP Sharing Mode 2 Support subfield.

When the Triggered TXOP Sharing Mode 2 Support subfield is set to the first parameter value, it indicates that the first TDLS device supports the target capability. That is, the first TDLS device can perform, within the first R-TWT SP, the low latency traffic transmission over the TDLS direct link. In some embodiments, the first parameter value can be 1.

Specifically, when the Triggered TXOP Sharing Mode 2 Support subfield is set to 1, it can indicate that the first TDLS device supports the target capability. When the Triggered TXOP Sharing Mode 2 Support subfield is set to 0, it can indicate that the first TDLS device does not support the target capability, that is, the first TDLS device cannot perform, within the first R-TWT SP, the low latency traffic transmission over the TDLS direct link.

Similarly, the EHT MAC Capabilities Information can be included in the EHT Capabilities element in the TDLS Setup Response frame or the TDLS Setup Request frame corresponding to the second TDLS device. Specifically, a parameter value of the Triggered TXOP Sharing Mode 2 Support subfield is included in the EHT MAC Capabilities Information, which can be used to determine whether the second TDLS device supports the target capability.

In the communication method performed by the first TDLS device provided in embodiments of the present disclosure, the first frame includes an MU-RTS TXS Trigger frame.

In some embodiments, the MU-RTS TXS Trigger frame can include a common information field, which includes a Triggered TXOP Sharing Mode subfield. The first identification information can be included in the Triggered TXOP Sharing Mode subfield.

When the Triggered TXOP Sharing Mode subfield is set to 2, it identifies a portion of a Transmission Opportunity (TXOP) allocated by the AP to the first TDLS device, which indicates that the first TDLS device can perform, within the portion of the TXOP, the low latency traffic transmission with the second TDLS device over the TDLS direct link.

In the communication method performed by the first TDLS device provided in embodiments of the present disclosure, it can further include following steps: a second frame is received, the second frame includes second identification information, and the second identification information indicates whether the R-TWT schedule supports the TDLS device to perform, within a corresponding SP, the low latency traffic transmission over the TDLS direct link.

The second frame can be sent by the AP. In some embodiments, the second frame includes a Beacon frame or a Probe Response frame. In some embodiments, the Probe Response frame can be an unrequested Probe Response frame.

The R-TWT schedule can be broadcasted through the second frame. By broadcasting the R-TWT schedule, it can be determined whether both the first TDLS device and the second TDLS device are both members of the first R-TWT schedule.

Specifically, the second frame can include the second identification information, which indicates whether the broadcasted R-TWT schedule supports the TDLS device to perform, within the corresponding SP, the low latency traffic transmission over the TDLS direct link established between the TDLS devices. That is, whether the first TDLS device that receives the second frame can perform, within the R-TWT SP, the low latency traffic transmission over the TDLS direct link established between the TDLS devices.

In the communication method performed by the first TDLS device provided in embodiments of the present disclosure, the second frame includes a TWT element.

The TWT element includes a Broadcast TWT Parameter Set field.

The Broadcast TWT Parameter Set field includes a Request Type subfield, which includes a Broadcast TWT Recommendation field.

The second identification information is included in the Broadcast TWT Recommendation field.

The second frame can include the TWT element, which can include the Broadcast TWT Parameter Set field. The Broadcast TWT Parameter Set field can include the Request Type subfield, which can include the Broadcast TWT Recommendation field. The Broadcast TWT Recommendation field can include the second identification information.

The value of the Broadcast TWT Recommendation field can be a third parameter value, which can be set according to actual needs. When the value of the Broadcast TWT Recommendation field is set to different values, the indicated contents are also different. For example, if the third parameter value is 5, it indicates that the R-TWT SP can be used for the low latency traffic transmission performed between TDLS devices over the TDLS direct link. An example is shown in Table 1 above.

In the communication method performed by the first TDLS device provided in embodiments of the present disclosure, after receiving the first frame, the first TDLS device performs, within the above portion of the TXOP, the low latency traffic transmission with the second TDLS device over the TDLS direct link.

When the first TDLS device performs, within the above portion of the TXOP, the low latency traffic transmission with the second TDLS device over the TDLS direct link, either data or data blocks can be used for the low latency traffic transmission.

After receiving the low latency traffic transmitted by the first TDLS device, the second TDLS device can feed back an ACK frame to the first TDLS device.

In embodiments of the present disclosure, the first TDLS device receives the first frame within the R-TWT SP, and determines, based on the first identification information in the first frame, that the AP has allocated the portion of the TXOP to the first TDLS device. For the R-TWT schedule that can be applied between TDLS devices, the low latency traffic transmission can be performed, within the portion of the TXOP, between the first TDLS device and the second TDLS device over the TDLS direct link established between them, without the participation of the AP, further reducing the transmission delay during the low latency traffic transmission and improving the transmission efficiency of the low latency traffic.

It should be noted that the communication method performed by the first TDLS device provided in embodiments of the present disclosure can also be performed by the second TDLS device, and relevant arrangements can be made according to actual needs, which will not be repeated here.

Embodiments of the present disclosure also provide a communication method, which is performed by a first TDLS device. The method includes following steps.

A first frame is received within a R-TWT SP.

In some embodiments, the first frame includes first identification information, which indicates a portion of a TXOP allocated by the AP to the first TDLS device.

The above portion of the TXOP is used for the first TDLS device to perform the low latency traffic transmission with the second TDLS device over the TDLS direct link.

The first TDLS device and the second TDLS device are both members of a first R-TWT schedule.

If both the first TDLS device and the second TDLS device support the target capability, the first frame is determined.

In some embodiments, the target capability includes performing the low latency traffic transmission over the TDLS direct link within the first R-TWT SP.

The EHT MAC Capabilities Information is included in the TDLS Setup Request frame or the TDLS Setup Response frame, and the EHT MAC Capabilities Information indicates whether the first TDLS device supports the above target capability.

When a Triggered TXOP Sharing Mode 2 Support subfield of the EHT MAC Capabilities Information is set to a first parameter value, it indicates that the first TDLS device supports the target capability.

The EHT MAC Capabilities Information is included in an EHT Capabilities element.

The above first frame includes an MU-RTS TXS Trigger frame.

The above method can further include following steps: a second frame is received, the second frame includes second identification information, and the second identification information indicates whether the R-TWT schedule supports the TDLS device to perform, within a corresponding SP, the low latency traffic transmission over the TDLS direct link.

The second frame includes a TWT element.

The TWT element includes a Broadcast TWT Parameter Set field.

The Broadcast TWT Parameter Set field includes a Request Type subfield, which includes a Broadcast TWT Recommendation field.

The second identification information is included in the Broadcast TWT Recommendation field.

After receiving the first frame, the first TDLS device performs, within the above portion of the TXOP, the low latency traffic transmission with the second TDLS device over the TDLS direct link.

In embodiments of the present disclosure, the first TDLS device receives the first frame within the R-TWT SP, and determines, based on the first identification information in the first frame, that the AP has allocated the portion of the TXOP to the first TDLS device. For the R-TWT schedule that can be applied between TDLS devices, the low latency traffic transmission can be performed, within the portion of the TXOP, between the first TDLS device and the second TDLS device over the TDLS direct link established between them, without the participation of the AP, further reducing the transmission delay during the low latency traffic transmission and improving the transmission efficiency of the low latency traffic.

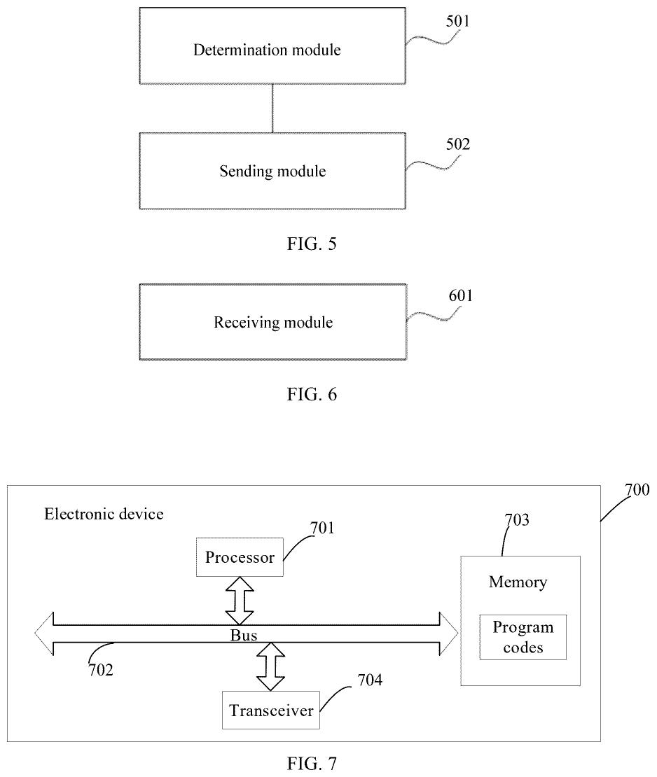

As shown in FIG. 5, based on the same principle as the method provided in some embodiments of the present disclosure, embodiments of the present disclosure also provide an electronic device. The electronic device is an access point (AP), which includes a determination module 501 and a sending module 502.

The determination module 501 is configured to determine a first frame. In some embodiments, the first frame includes first identification information, and the first identification information indicates a portion of a TXOP allocated by the AP to a first TDLS device. The above portion of the TXOP is used for the first TDLS device to perform low latency traffic transmission with a second TDLS device over a TDLS direct link. In some embodiments, the first TDLS device and the second TDLS device are both members of a first R-TWT schedule.

The sending module 502 is configured to send the first frame within a first R-TWT SP.

Embodiments of the present disclosure also provide a communication device, which is applied to an access point (AP). The communication device includes a frame determination module and a frame sending module.

The frame determination module is configured to determine a first frame. In some embodiments, the first frame includes first identification information, and the first identification information indicates a portion of a TXOP allocated by the AP to a first TDLS device. The above portion of the TXOP is used for the first TDLS device to perform low latency traffic transmission with a second TDLS device over a TDLS direct link. In some embodiments, the first TDLS device and the second TDLS device are both members of a first R-TWT schedule.

The frame sending module is configured to send the first frame within a first R-TWT SP.

The device also includes other modules of the electronic device in the previous embodiments, which will not be repeated here.

As shown in FIG. 6, based on the same principle as the method provided in some embodiments of the present disclosure, embodiments of the present disclosure also provide an electronic device. The electronic device is a first TDLS device, which includes a receiving module 601.

The receiving module 601 is configured to receive a first frame within an SP of a first R-TWT schedule. In some embodiments, the first frame includes first identification information, and the first identification information indicates a portion of a TXOP allocated by an AP to the first TDLS device. The above portion of the TXOP is used for the first TDLS device to perform low latency traffic transmission with a second TDLS device over a TDLS direct link. In some embodiments, the first TDLS device and the second TDLS device are both members of a first R-TWT schedule.

Embodiments of the present disclosure also provide a communication device, which is applied to a first TDLS device. The communication device includes a frame receiving module.

The frame receiving module is configured to receive a first frame within an SP of a first R-TWT schedule. In some embodiments, the first frame includes first identification information, and the first identification information indicates a portion of a TXOP allocated by an AP to the first TDLS device. The above portion of the TXOP is used for the first TDLS device to perform low latency traffic transmission with a second TDLS device over a TDLS direct link. In some embodiments, the first TDLS device and the second TDLS device are both members of a first R-TWT schedule.

The device also includes other modules of the electronic device in the previous embodiment, which will not be repeated here.

In some embodiments, the present disclosure also provides an electronic device, as shown in FIG. 7. The electronic device 700 shown in FIG. 7 can be a server, and includes a processor 701 and a memory 703. In some embodiments, the processor 701 is connected to the memory 703, for example, connected via a bus 702. In some embodiments, the electronic device 700 can further include a transceiver 704. It should be noted that in practical applications, the transceiver 704 is not limited to one transceiver, and the structure of the electronic device 700 does not constitute a limitation on embodiments of the present disclosure.

The processor 701 can be a CPU (Central Processing Unit), a general-purpose processor, a DSP (Digital Signal Processor), an ASIC (Application Specific Integrated Circuit), an FPGA (Field Programmable Gate Array), or other programmable logic devices, transistor logic devices, hardware components, or any combination thereof, which can implement or execute various exemplary logical blocks, modules, and circuits described in conjunction with the present disclosure. The processor 701 can also be a combination of computing functions, such as a combination containing one or more microprocessors, a combination containing the DSP and the microprocessor, etc.

The bus 702 can include a path for delivering information between the aforementioned components. The bus 702 can be a PCI (Peripheral Component Interconnect) bus or an EISA (Extended Industry Standard Architecture) bus, etc. The bus 702 can be divided into an address bus, a data bus, a control bus, etc. For ease of representation, only one thick line is used in FIG. 7, but it does not mean that there is only one bus or one type of bus.

The memory 703 can be ROM (Read Only Memory) or other types of static storage devices that can store static information and instructions, RAM (Random Access Memory) or other types of dynamic storage devices that can store information and instructions, or EEPROM (Electrically Erasable Programmable Read Only Memory), CD-ROM (Compact Disc Read Only Memory), or other optical disk storage devices, optical disc storage devices (including compressed discs, laser discs, optical discs, digital universal discs, Blu-ray discs, etc.), magnetic disk storage media or other magnetic storage devices, or any other media that can be used to carry or store desired program codes in the form of instructions or data structures and can be accessed by computers, but not limited to this.

The memory 703 is used to store application program codes for implementing the present disclosure, and the execution of the codes is controlled by the processor 701. The processor 701 is used to execute the application program codes stored in the memory 703 to implement the methods provided in the aforementioned method embodiments.

In some embodiments, the electronic device includes but is not limited to mobile phones, laptops, digital broadcasting receivers, PDAs (Personal Digital Assistant), PADs (tablet), PMPs (Portable Multimedia Player), in-vehicle terminals (such as in-vehicle navigation terminals), and fixed terminals such as digital TVs, desktop computers, and so on. The electronic device shown in FIG. 7 is only an example and should not impose any limitations on the functionality and the use scope of embodiments of the present disclosure.

The server provided in the present disclosure can be an independent physical server, a server cluster or a distributed system composed of multiple physical servers, or a cloud server that provides basic cloud computing services such as cloud service, cloud database, cloud computing, cloud function, cloud storage, network service, cloud communication, middleware service, domain name service, security service, CDN, as well as big data and artificial intelligence platform. The terminal can be smartphone, tablet, laptop, desktop computer, smart speaker, smartwatch, etc., but is not limited to this. The terminal and the server can be directly or indirectly connected through wired or wireless communication methods, and the present disclosure is not limited here.

Embodiments of the present disclosure provide a non-transitory computer-readable storage medium on which a computer program is stored. When the computer program is running on a computer, enables the computer to implement the corresponding content of the aforementioned method embodiments.

It should be understood that although the various steps in the flowchart in the drawings are displayed in sequence indicated by arrows, these steps are not necessarily executed in the order indicated by the arrows. Unless explicitly stated in the article, the execution of these steps does not have strict order restrictions and can be included out in other orders. Moreover, at least a portion of the steps in the flowchart of the drawings can include multiple sub steps or stages, which may not necessarily be completed at the same time, but may be executed at different times, and their execution order may not necessarily be in sequence, but may rotate or alternate with at least a portion of other steps or sub steps or stages.

It should be noted that the non-transitory computer-readable medium mentioned in the present disclosure can be a computer-readable signal medium, a computer-readable storage medium, or any combination of the two. The computer-readable storage medium can be, but is not limited to, an electrical, magnetic, optical, electromagnetic, infrared, or semiconductor system, apparatus, or device, or any combination thereof. More specific examples of the computer-readable storage medium can include, but are not limited to: electrical connections with one or more wires, portable computer disks, hard drives, random access memory (RAM), read-only memory (ROM), erasable programmable read-only memory (EPROM or flash), fiber optics, portable compact disk read-only memory (CD-ROM), optical storage devices, magnetic storage devices, or any suitable combination of the above. In the present disclosure, a computer-readable storage medium can be any tangible medium containing or storing a program, which can be used by an instruction execution system, apparatus, or device, or in combination with it. In the present disclosure, the computer-readable signal medium can include data signals propagated in the baseband or as part of the carrier wave, which carry computer-readable program codes. This type of transmitted data signal can take various forms, including but not limited to electromagnetic signals, optical signals, or any suitable combination of the above. The computer-readable signal medium can also be any computer-readable medium other than a computer-readable storage medium, which can send, propagate, or transmit programs for use by an instruction execution system, apparatus, or device, or in combination with it. The program code contained on the computer-readable medium can be transmitted using any appropriate medium, including but not limited to: wires, optical cables, RF (radio frequency), etc., or any suitable combination of the above.

The above-mentioned computer-readable medium can be included in the electronic device mentioned above. It can also exist separately without being assembled into the electronic device.

The above-mentioned computer-readable medium carries one or more programs, which, when executed by the electronic device, cause the electronic device to implement the methods shown in the above embodiments.

According to one aspect of the present disclosure, a computer program product or a computer program is provided, including computer instructions stored in a computer-readable storage medium. The processor of a computer device reads the computer instructions from the computer-readable storage medium, executes the computer instructions, and causes the computer device to implement the methods provided in the various embodiments mentioned above.

The computer program codes for implementing the operations disclosed herein can be written in one or more programming languages or combinations thereof, including object-oriented programming languages such as Java, Smalltalk, C++, and conventional procedural programming languages such as C or similar programming languages. The program codes can be completely executed on the user's computer, partially executed on the user's computer, executed as an independent software package, partially executed on the user's computer and partially executed on a remote computer, or completely executed on the remote computer or a server. In the case where remote computers are involved, the remote computer can be connected to the user computer through any type of networks, including local area networks (LAN) or wide area networks (WAN), or can be connected to an external computer (such as connected via the internet provided by internet service providers).

The flowchart and the block diagram in the drawings illustrate the possible architectures, functions, and operations of the systems, methods, and computer program products according to various embodiments of the present disclosure. Each box in a flowchart or block diagram can represent a module, a program segment, or a part of codes that contain one or more executable instructions for implementing a specified logical function. It should also be noted that in some embodiments, the functions indicated in the box can also occur in a different order than those indicated in the drawings. For example, two consecutive boxes can actually be executed in basic parallel order, and sometimes they can also be executed in opposite order, depending on the functionality involved. It should also be noted that each box in the block diagram and/or flowchart, as well as the combination of boxes in the block diagram and/or flowchart, can be implemented using dedicated hardware based systems that perform specified functions or operations, or can be implemented using a combination of dedicated hardware and computer instructions.

The modules described in embodiments of the present disclosure can be implemented through software or hardware. In some embodiments, the name of the module does not constitute a limitation on the module itself in a certain situation. For example, module A can also be described as “module A used to perform operation B”.

The above description is only for embodiments of the present disclosure and an explanation of the technical principles involved. Those skilled in the art should understand that the scope of the present disclosure is not limited to technical solutions formed by specific combinations of the technical features mentioned above, and should also cover other technical solutions formed by arbitrary combinations of the technical features mentioned above or their equivalent features without departing from the concept disclosed. For example, a technical solution formed by replacing the above features with technical features with similar functions disclosed (but not limited to) in the present disclosure.

1. A communication method, performed by an access point (AP), the method comprising:
determining a first frame, wherein the first frame comprises first identification information, the first identification information indicates a portion of an obtained Transmission Opportunity (TXOP) allocated by the AP to a first Tunneled Direct Link Setup (TDLS) device, and the portion of the obtained TXOP is used for the first TDLS device to perform low latency traffic transmission with a second TDLS device over a TDLS direct link, and wherein the first TDLS device and the second TDLS device are both members of a first Restricted Target Wake Time (R-TWT) schedule; and
sending the first frame within a first R-TWT Service Period (SP).

2. The communication method according to claim 1, wherein when determining that both the first TDLS device and the second TDLS device support a target capability, the first frame is determined, and wherein the target capability comprises performing the low latency traffic transmission over the TDLS direct link within the first R-TWT SP.

3. The communication method according to claim 2, wherein determining the first frame comprises:
determining whether the TDLS device supports the target capability based on Extremely High Throughput (EHT) Media Access Control (MAC) Capabilities Information transmitted by the TDLS device;
wherein the TDLS device comprises at least one of the first TDLS device or the second TDLS device.

4. The communication method according to claim 3, wherein a Triggered TXOP Sharing Mode 2 Support subfield of the EHT MAC Capabilities Information indicates that the TDLS device supports the target capability when the Triggered TXOP Sharing Mode 2 Support subfield is set to a first parameter value;
wherein the EHT MAC Capabilities Information is comprised in an EHT Capabilities element.

5. The communication method according to claim 1, wherein the first frame comprises a Multi-User Request to Send Transmission Opportunity Sharing (MU-RTS TXS) Trigger frame.

6. The communication method according to claim 1, further comprising:
determining a second frame, wherein the second frame comprises second identification information, and the second identification information indicates whether the first R-TWT schedule supports the TDLS device to perform, within a corresponding R-TWT SP, the low latency traffic transmission over the TDLS direct link; and
sending the second frame.

7. The communication method according to claim 6, wherein the second frame comprises a TWT element;
the TWT element comprises a Broadcast TWT Parameter Set field;
the Broadcast TWT Parameter Set field comprises a Request Type subfield, and the Request Type subfield comprises a Broadcast TWT Recommendation field; and
wherein the second identification information is comprised in the Broadcast TWT Recommendation field.

8. A communication method, performed by a first Tunneled Direct Link Setup (TDLS) device, the method comprising:
receiving a first frame within a first Restricted Target Wake Time (R-TWT) Service Period (SP);
wherein the first frame comprises first identification information, the first identification information indicates a portion of an obtained Transmission Opportunity (TXOP) allocated by an access point (AP) to the first TDLS device, and the portion of the obtained TXOP is used for the first TDLS device to perform low latency traffic transmission with a second TDLS device over a TDLS direct link, and wherein the first TDLS device and the second TDLS device are both members of a first R-TWT schedule.

9. The communication method according to claim 8, wherein when both the first TDLS device and the second TDLS device support a target capability, the first frame is determined, and wherein the target capability comprises performing the low latency traffic transmission over the TDLS direct link within the first R-TWT SP.

10. The communication method according to claim 9, further comprising:
indicating whether the first TDLS device supports the target capability through Extremely High Throughput (EHT) Media Access Control (MAC) Capabilities Information.

11. The communication method according to claim 10, wherein a Triggered TXOP Sharing Mode 2 Support subfield of the EHT MAC Capabilities Information indicates that the first TDLS device supports the target capability when the Triggered TXOP Sharing Mode 2 Support subfield is set to a first parameter value;
wherein the EHT MAC Capabilities Information is comprised in an EHT Capabilities element.

12. The communication method according to claim 8, wherein the first frame comprises a Multi-User Request to Send Transmission Opportunity Sharing (MU-RTS TXS) Trigger frame.

13. The communication method according to claim 8, further comprising:
receiving a second frame, wherein the second frame comprises second identification information, and the second identification information indicates whether the first R-TWT schedule supports the TDLS device to perform, within a corresponding R-TWT SP, the low latency traffic transmission over the TDLS direct link.

14. The communication method according to claim 13, wherein the second frame comprises a TWT element;
the TWT element comprises a Broadcast TWT Parameter Set field;
the Broadcast TWT Parameter Set field comprises a Request Type subfield, and the Request Type subfield comprises a Broadcast TWT Recommendation field; and
wherein the second identification information is comprised in the Broadcast TWT Recommendation field.

15. The communication method according to claim 8, further comprising:
performing, within the portion of the TXOP, the low latency traffic transmission with the second TDLS device over the TDLS direct link after receiving the first frame.

16.-17. (canceled)

18. An access point (AP) comprising a memory, a processor, and a computer program stored on the memory and executable by the processor, wherein the processor is configured to execute the computer program to implement the method according to claim 1.

19. A non-transitory computer-readable storage medium having a computer program stored thereon, which when executed by a processor, causes the method according to claim 1 to be implemented.

20. A first Tunneled Direct Link Setup (TDLS) device comprising a memory, a processor, and a computer program stored on the memory and executable by the processor, wherein the processor is configured to execute the computer program to implement the method according to claim 8.

21. A non-transitory computer-readable storage medium having a computer program stored thereon, which when executed by a processor, causes the method according to claim 8 to be implemented.

22. The communication method according to claim 6, wherein the second frame comprises a Beacon frame or a Probe Response frame.
